(19) United States
(12) Patent Application Publication
(10) Pub. No.: US 2009/0055236 A1
(43) Pub. Date: Feb. 26, 2009

(54) SYSTEM AND METHOD FOR EVALUATING LIKELIHOOD OF MEETING ATTENDANCE

(75) Inventors: Patrick Joseph O'Sullivan, Ballsbridge (IE); Gary Denner, Co. Kildare (IE); Carol Sue Zimmet, Boxborough, MA (US); Ruthie D. Lyle, Durham, NC (US)

Correspondence Address: HOLLAND & KNIGHT, 10 ST. JAMES AVENUE, BOSTON, MA, 02116-3889, US

(73) Assignee: INTERNATIONAL BUSINESS MACHINES CORPORATION, Armonk, NY (US)

(21) Appl. No.: 11/843,923

(22) Filed: Aug. 23, 2007

(51) Int. Cl. G06Q 10/00

(52) U.S. Cl. 705/8

(57) ABSTRACT

A method and computer program product for evaluating the likelihood of meeting attendance including receiving an acceptance to an invitation to a first meeting for a meeting invitee. A first weighting factor is defined for the meeting invitee based upon, at least in part, an anticipated probability of attendance at the first meeting by the meeting invitee. The first weighting factor is associated with the meeting invitee and the first meeting.

### TECHNICAL FIELD

This disclosure relates to meeting scheduling and, more particularly, to systems and methods for evaluating the likelihood of meeting attendance.

### BACKGROUND

Situations oftentimes arise where individuals miss key meetings or meeting events simply because they have overbooked themselves, or have overbooked others, on calendar invitations. Oftentimes, meetings may be scheduled around the availability of a key person who initially accepts a meeting invitation. However the key person may subsequently accept other invitations for the same time, resulting in originally accepted meeting invitations being superseded by later accepted meeting invitations. Such situations make it a difficult task for meeting schedulers to establish a plurality of individuals for a calendar invitation that is deemed important to succeed.

The meeting scheduler may assign a meeting time that represents a free slot for a plurality of individuals via calendar polling. Absentees (in terms of those who have accepted) may represent no-shows, because, in the intermediate time, one or more of the individuals have received subsequent new invitations that represent higher priorities for the individual in question. Good practice would suggest that the new accept would motivate the accepter to decline the previously accepted meeting for this time, however, this is not a common practice. As such, the mere acceptance of a meeting invitation may often not provide an accurate indication of whether an individual will actually attend the meeting.

### SUMMARY OF DISCLOSURE

In a first implementation, a method includes receiving an acceptance to an invitation to a first meeting for a meeting invitee. A first weighting factor for the meeting invitee is defined based upon, at least in part, an anticipated probability of attendance at the first meeting by the meeting invitee. The first weighting factor is associated with the meeting invitee and the first meeting.

One or more of the following features may be included. Defining the first weighting factor may include receiving an anticipated probability of attendance for the meeting invitee. The first weighting factor may be based upon, at least in part, an attendance history of the meeting invitee. The first weighting factor for the meeting invitee may be based upon, at least in part, an availability of the meeting invitee. The method may also include publishing the first weighting factor associated with the meeting invitee.

Defining the first weighting factor may further include defining at least a first meeting subpart and defining at least a second meeting subpart. Defining the first weighting factor may also included defining a first subpart weighting factor based upon, at least in part, an anticipated probability of attendance at the first meeting subpart and defining a second subpart weighting factor based upon, at least in part, an anticipated probability of attendance at the second meeting subpart.

The method may also include receiving an acceptance to an invitation to a second meeting for the meeting invitee, the second meeting conflicting with the first meeting. A second weighting factor may be defined for the meeting invitee based upon, at least in part, an anticipated probability of attendance at the second meeting by the meeting invitee. The second weighting factor may be associated with the meeting invitee and the second meeting. Additionally, the first weighting factor associated with the meeting invitee and the first meeting may be adjusted based upon, at least in part, the second weighting factor. Adjusting the first weighting factor may include receiving an anticipated probability of attendance at the second meeting for the meeting invitee. The anticipated probability of attendance at the second meeting may be based upon, at least in part, the anticipated probability of attendance at the first meeting received from the meeting invitee. The method may also include updating one of the first weighting factor and the second weighting factor based upon, at least in part, a resolution of the conflict between the first meeting and the second meeting.

According to another implementation, a computer program product resides on a computer readable medium having a plurality of instructions stored thereon. When executed by a processor the instructions cause the processor to perform operations including receiving an acceptance to an invitation to a first meeting for a meeting invitee. A first weighting factor is defined for the meeting invitee based upon, at least in part, an anticipated probability of attendance at the first meeting by the meeting invitee. The first weighting factor is associated with the meeting invitee and the first meeting.

One or more of the following features may be included. The instructions for defining the first weighting factor may include instructions for receiving an anticipated probability of attendance for the meeting invitee. The first weighting factor may be based upon, at least in part, an attendance history of the meeting invitee. The first weighting factor for the meeting invitee may be based upon, at least in part, an availability of the meeting invitee. The computer program product may further include instructions for publishing the first weighting factor associated with the meeting invitee.

The instructions for defining the first weighting factor may further include instructions for defining at least a first meeting subpart and for defining at least a second meeting subpart. The instructions for defining the first weighting factor may further include instructions for defining a first subpart weighting factor based upon, at least in part, an anticipated probability of attendance at the first meeting subpart and for defining a second subpart weighting factor based upon, at least in part, an anticipated probability of attendance at the second meeting subpart.

The computer program product may further include instructions for receiving an acceptance to an invitation to a second meeting for the meeting invitee, the second meeting conflicting with the first meeting. A second weighting factor may be defined for the meeting invitee based upon, at least in part, an anticipated probability of attendance at the second meeting by the meeting invitee. The second weighting factor may be associated with the meeting invitee and the second meeting. The first weighting factor associated with the meeting invitee and the first meeting may be adjusted based upon, at least in part, the second weighting factor. The instructions for adjusting the first weighting factor may include instructions for receiving an anticipated probability of attendance at the second meeting for the meeting invitee. The anticipated probability of attendance at the second meeting may be based upon, at least in part, the anticipated probability of attendance at the first meeting received from the meeting invitee. Instructions may also be included for updating one of the first weighting factor and the second weighting factor based upon, at least in part, a resolution of the conflict between the first meeting and the second meeting.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an attendance weighting process and email application coupled to a distributed computing network.

FIG. 2 is a diagrammatic view of a display screen rendered by the attendance weighting process and/or email application of FIG. 1, including a meeting invitation.

FIG. 3 is a flowchart of a process executed by the attendance weighting process of FIG. 1.

FIG. 4 is a diagrammatic view of a display screen rendered by the attendance weighting process and/or email application of FIG. 1, including a meeting invitation.

FIG. 5 is a diagrammatic view of a calendar rendered by the attendance weighting process and/or email application of FIG. 1, including a scheduled meeting.

FIG. 6 is a diagrammatic view of a display screen rendered by the attendance weighting process and/or email application of FIG. 1, including a first and a second meeting invitation.

FIG. 7 is a diagrammatic view of a display screen rendered by the attendance weighting process and/or email application of FIG. 1, including a first and second meeting invitation.

### DETAILED DESCRIPTION OF THE PREFERRED EMBODIMENTS

### System Overview:

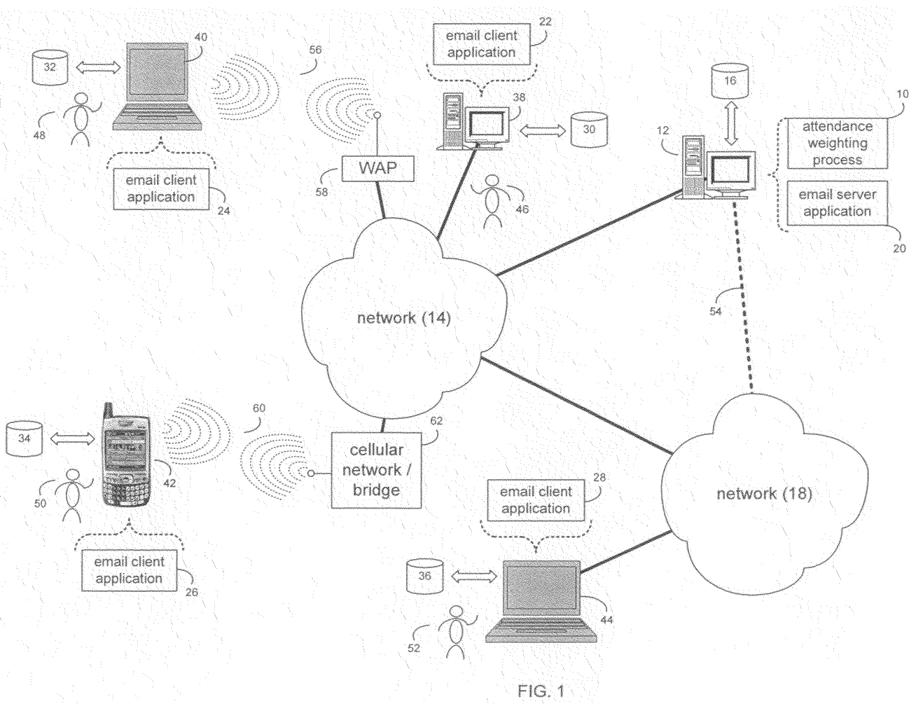

Referring to FIG. 1, there is shown attendance weighting process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Alternatively, attendance weighting process 10 may reside on and be executed, in whole or in part, by a client electronic device, such as a personal computer, notebook computer, personal digital assistant, or the like.

As will be discussed below in greater detail, attendance weighting process may receive an acceptance to an invitation to a first meeting for a meeting invitee. A first weighting factor for the meeting invitee may be defined based upon, at least in part, an anticipated probability of attendance at the first meeting by the meeting invitee. The first weighting factor may be associated with the meeting invitee and the first meeting. In the foregoing manner, attendance weighting process may allow the likelihood that a meeting invitee will attend a meeting to be evaluated, thereby allowing moderators, other meeting invitees, and the like, to better schedule meetings and to develop meeting itineraries considering the probability of attendance of various meeting invitees.

The instruction sets and subroutines of attendance weighting process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute a calendar/scheduling application, e.g., which may be a module of email server application 20, examples of which may include but are not limited to Lotus Domino™ Server and Microsoft Exchange™ Server. Email server application 20 may store calendar and/or scheduling information for one or more calendar/scheduling client applications, e.g., email client applications 22, 24, 26, 28 including calendar/scheduling modules, examples of which may include but are not limited to Lotus Notes™ and Microsoft Outlook™ Attendance weighting process 10 may be a stand alone application that interfaces with email server application 20 or an applet/application that is executed within email server application 20.

The instruction sets and subroutines of email server application 20, which may be stored on storage device 16 coupled to server computer 12 may be executed by one or more processors (not shown) and one or more memory architectures (not shown) incorporated into server computer 12.

As mentioned above, in addition/as an alternative to being a server-based application residing on server computer 12, the attendance weighting process may be a client-side application (not shown) residing on one or more storage device (e.g., stored on storage device 30, 32, 34, 36) coupled to one or more client electronic device (e.g., client electronic devices 38, 40, 42, 44, respectively). As such, the attendance weighting process may be a stand alone application that interfaces with calendar/scheduling client application (e.g., email client applications 22, 24, 26, 28), or may be an applet/application that is executed within a calendar/scheduling application client application (e.g., email client applications 22, 24, 26, 28). As such, the attendance weighting process may be a client-side process, a server-based application, or a hybrid client-side/server-based process, which may be executed, in whole or in part, by server computer 12, or one or more of client electronic device 38, 40, 42, 44.

The instruction sets and subroutines of email client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and a memory stick storage devices. Examples of computing devices 38, 40, 42, 44 may include, but are not limited to, personal computer 38, laptop computer 40, personal digital assistant 42. notebook computer 44, a data-enabled, cellular telephone (not shown), and a dedicated network device (not shown), for example. Using email client applications 22, 24, 26, 28, users 46, 48, 50, 52 may access email server application 20 and may retrieve and/or create scheduled events, such as meetings and appointments.

Users 46, 48, 50, 52 may access email server application 20 directly through the device on which the calendar/scheduling client application (e.g., email client applications 22, 24, 26, 28) is executed, namely client electronic devices 38, 40, 42, 44, for example. Users 46, 48, 50, 52 may access email server application 20 directly through network 14 or through secondary network 18. Further, server computer 12 (i.e., the computer that executes email server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### The Attendance Weighting Process:

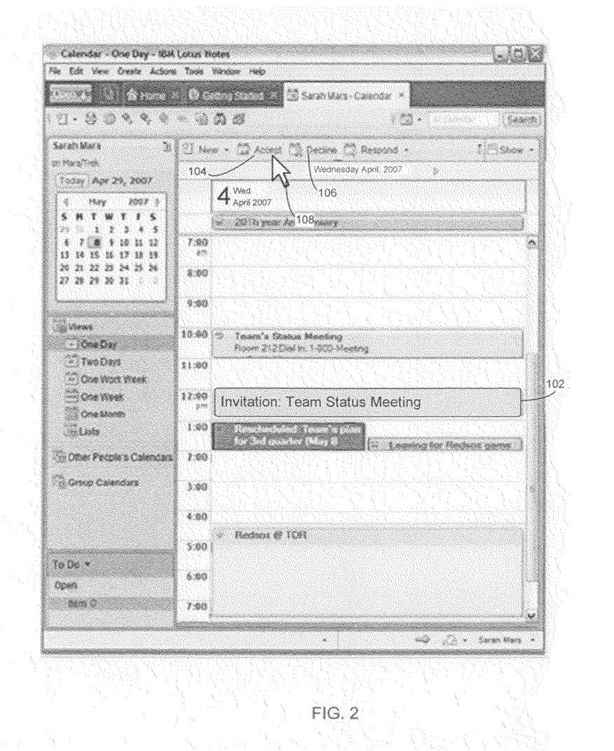

Referring also to FIG. 2, a calendar and/or scheduling client application (e.g., email client application 22) may render display screen 100. As discussed above, email client application 22 may interface with email server application 20 and facilitate access to and manipulation of scheduling events, such as appointments and meetings, available from email server application 20.

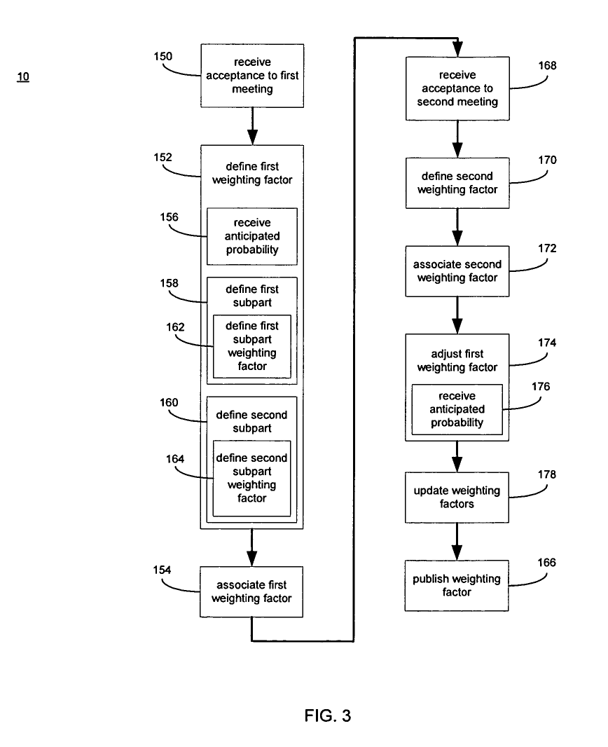

Display screen 100 may include an invitation to a meeting (e.g., invitation 102 to “Team Status Meeting”). A user (e.g., user 46) may accept or decline invitation 102 to “Team Status Meeting”, e.g., by selecting “Accept” button 104 or “Decline” button 106 using onscreen pointer 108 controlled by a pointing device (e.g., a mouse; not shown). Referring also to FIG. 3, in response to user 46 selecting “Accept” button 104, attendance weighting process 10 may receive 150 the acceptance of invitation 102 to “Team Status Meeting”. When attendance weighting process 10 receives 150 the acceptance of invitation 102, attendance weighting process 10 may define 152 a weighting factor for user 46 based upon, at least in part, an anticipated probability of user 46 attending the “Team Status Meeting”. Attendance weighting process 10 may associate 154 the weighting factor defined 152 for user 46 with user 46 and the “Team Status Meeting”.

The weighting factor associated 154 with user 46 and the “Team Status Meeting” may provide at least an approximate likelihood that user 46 will attend the “Team Status Meeting”. The likelihood that various meeting invitees (e.g., user 46) will attend the meeting (e.g., the “Team Status Meeting”) may allow moderators and/or other meeting attendees to make informed decision regarding topics to be discussed at the meeting, whether the meeting should be rescheduled for another time, and so on. For example, if user 46 is considered to be a critical attendee at the “Team Status Meeting”, but may not be able to attend the meeting, e.g., as reflected by a relatively low attendance weighting factor, a meeting moderator and/or other meeting attendees may decide to reschedule the “Team Status Meeting” for another time, e.g., at which time user 46 may have a greater probability of attending the meeting.

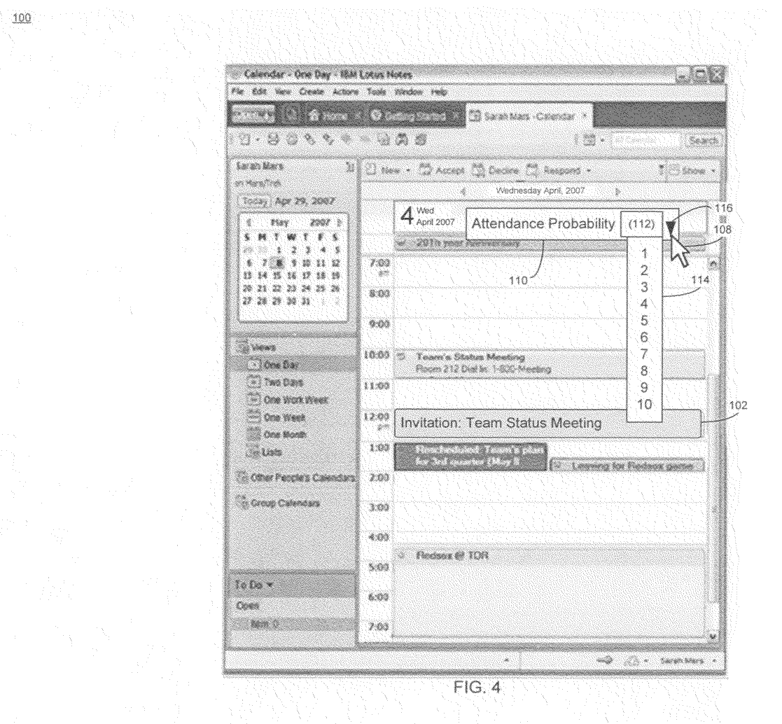

Continuing with the above-stated example, attendance weighting process 10 may receive 156 an anticipated probability of user 46 attending the “Team Status Meeting”. Attendance weighting process 10 may define 152 the weighting factor based upon, at least in part, the received 156 anticipated probability of user 46 attending the “Team Status Meeting”. For example, referring also to FIG. 4, when user 46 selects “Accept” button 104, attendance weighting process 10 and/or email client application 22 may render popup 110 including, e.g., “Attendance Probability” field 112. User 46 may input (e.g., using a keyboard associated with personal computer 38; not shown) an anticipated probability of attending the “Team Status Meeting”, e.g., on a scale of 1-10, as a percentage probability, or based upon a similar scale.

As an alternative to directly inputting the anticipated probability of attending the “Team Status Meeting”, user 46 may activate selection menu 114, e.g., by selecting option arrow 116 in popup 110 using onscreen pointer 108, controlled by the pointing device. Selection menu 114 may define a plurality of relative probability values, e.g., 1-10 indicating an increasing probability of attending the meeting. Using onscreen pointer 110, user 46 may select a probability value indicting the anticipated probability that user 46 will attend the “Team Status Meeting”. For example, user 46 may not have any meetings or appointments scheduled for the time proposed for the “Team Status Meeting”, e.g., as indicated by invitation 102. As such, user 46 may select a probability value of 10, indicating that user 46 anticipates attending the “Team Status Meeting”. Attendance weighting process 10 may receive 156 the anticipated probability for user 46 attending the “Team Status Meeting”. Attendance weighting process 10 may define 152 the weighting factor based upon, at least in part, the received 156 anticipated probability.

In addition/as an alternative to receiving 156 the anticipated probability of attending the meeting from the invitee, attendance weighting process 10 may receive 156 the anticipated probability from another source. For example, an administrative assistant for the meeting invitee may indicate his/her anticipated probability that the meeting invitee will attend the meeting. In another example, a supervisor of the meeting invitee may provide an anticipated probability that the meeting invitee will attend the meeting, e.g., based upon the importance of attendance. Attendance weighting process 10 may receive 156 the anticipated probability that the meeting invitee will attend the meeting from various additional/alternative sources.

Attendance weighting process 10 may additionally/alternatively define 152 the weighting factor based upon, at least in part, an attendance history of the meeting invitee. Continuing with the above stated example, user 46 may often accept invitations to meetings, but may not always end up attending the meeting. For example, user 46 may attend 70% of the meetings for which invitations are accepted. Based upon, at least in part, user 46's attendance history, attendance weighting process 10 may define 152 the weighting factor to be 7 (e.g., out of 10), based upon user 46's 70% attendance history for accepted meetings.

Furthermore, attendance weighting process 10 may scale an anticipated attendance probability received 156 for user 46 based upon, at least in part, user 46's attendance history. Continuing with the above-stated example in which user 46 has a 70% attendance history for accepted meetings, if attendance weighting process 10 receives 156 a 7 (e.g., out of 10) anticipated probability of attendance for user 46, attendance weighting process 10 may scale the anticipated probability of attendance to 49% (e.g., 70% of 7 out of 10). As such, attendance weighting process 10 may define 152 a weighting factor of 5 out of 10 (i.e., approximately 49%). In the foregoing manner, the weighting factor may be based upon, at least in part, an attendance history of user 46 as well as a received 156 anticipated probability of attendance.

In addition to a general attendance history (i.e., a history of attending all meetings), attendance weighting process 10 may define 152 the weighting factor for a recurring meeting (e.g., a recurring weekly or monthly meeting) based upon the user's attendance history at the recurring meeting. For example, “Team Status Meeting” may be a recurring meeting, e.g., occurring every month. User 46 may have an attendance history for the recurring “Team Status Meeting” of 90%, while only having an attendance history of 70% for all meetings. Continuing with this example, attendance weighting process 10 may define 155 the weighting factor for user 46 attending recurring “Team Status Meeting” to be a 9 (e.g., out of 10) based upon user 46's attendance history for the recurring “Team Status Meeting” rather than a 7 (e.g., out of 10) reflecting user 46's overall attendance history for all meetings.

Additionally/alternatively the attendance weighting factor defined 152 for user 46 attending the recurring “Team Status Meeting” may also be based upon, at least in part, other factors (e.g., other accepted meetings for the same time, user provided probability, as well as similar factors). In a related manner, attendance weighting process 10 may define 152 an attendance weighting factor for user 46 attending a meeting accepted for the same time as recurring “Team Status Meeting” (for which user 46 has a 90% attendance history) based upon, at least in part, user 46's attendance history at the recurring “Team Status Meeting”.

The weighting factor for the meeting invitee may additionally/alternatively be based upon, at least in part, an awareness of the meeting by the meeting invitee. Continuing with the above-stated example, invitation 102 to the “Team Status Meeting” may be accepted on behalf of user 46 (e.g., user 46 may be added to a meeting attendance list without using a formal invite/acceptance protocol, or invitation 102 may be accepted by user 46's administrative assistant). Attendance weighting process 10 may, for example, ascertain that user 46 has not read email since invitation 102 to “Team Status Meeting” was sent. For example, attendance weighting process may monitor and/or analyze user 46's activity patterns (e.g., to determine if user 46 has checked email, viewed calendar, or similar activities) Even if user 46 does not have another appointment scheduled for the time period of the meeting, it may be unknown whether user 46 will in fact be able to attend the “Team Status Meeting”. As such, attendance weighting process 10 may define 152 a weighting factor based upon user 46's lack of awareness of the meeting. For example, attendance weighting process 10 may define 152 a weighting factor of 5 out of 10 (e.g., indicating a 50% probability that user 46 will be able to attend the meeting). As such, the uncertainty as to whether user 46 will attend the meeting may be accounted for, e.g., for planning purposed.

Attendance weighting process 10 may also define 152 a weighting factor based upon the availability of a meeting invitee. Continuing with the above stated example, user 46 may not have a previously scheduled meeting/appointment for the time designated by invitation 102 (i.e., from 12:00 to 1:00). As such, attendance weighting process 10 may define 152 a weighting factor of 10 out 10 based upon user 46's apparent availability during the time of the “Team Status Meeting”. The weighting factor defined 152 for user 46 may be based upon, at least in part, the high anticipated probability that user 46 will be able to attend the meeting based upon user 46's apparent availability.

In some instances (e.g., for a relatively long meeting, or a meeting have multiple discrete agenda items), defining 152 the weighting factor may include dividing the meeting into two or more meeting subparts and defining weighting factors for each of the two or more meeting subparts. For example, user 46 may have a high anticipated probability of being able to attend the first half of the “Team Status Meeting”. However, user 46 may believe that he may not be able to attend the second half of the meeting (e.g., as a result of a prior commitment, or such). Attendance weighting process 10 may define 158, 160 a first and second meeting subpart, e.g., corresponding to the first and second halves of the “Team Status Meeting”. Further, attendance weighting process 10 may define 162 a first subpart weighting factor (e.g., based upon, at least in part, a high probability that user 46 will be able to attend the first half of the meeting) and may define 164 a second subpart weighting factor (e.g., based upon, at least in part, a relatively lower probability that user 46 will be able to attend the second half of the meeting). In addition/as an alternative to separately defining 162, 164 a first subpart weighting factor and a second subpart weighting factor, attendance weighting process may define 152 an attendance weighting factor that is an average of the defined 162 first subpart weighting factor and the defined 164 second subpart weighting factor.

Continuing with the preceding example, if user 46 is essential to only a portion of the “Team Status Meeting”, a moderator may set the meeting agenda to address the topics for which user 46 is essential during the subpart of the “Team Status Meeting” for which user 46 has the highest associated weighting factor (e.g., the first subpart of the “Team Status Meeting”). The “Team Status Meeting” can, therefore, be planned to accommodate user 46's anticipated probability of attendance.

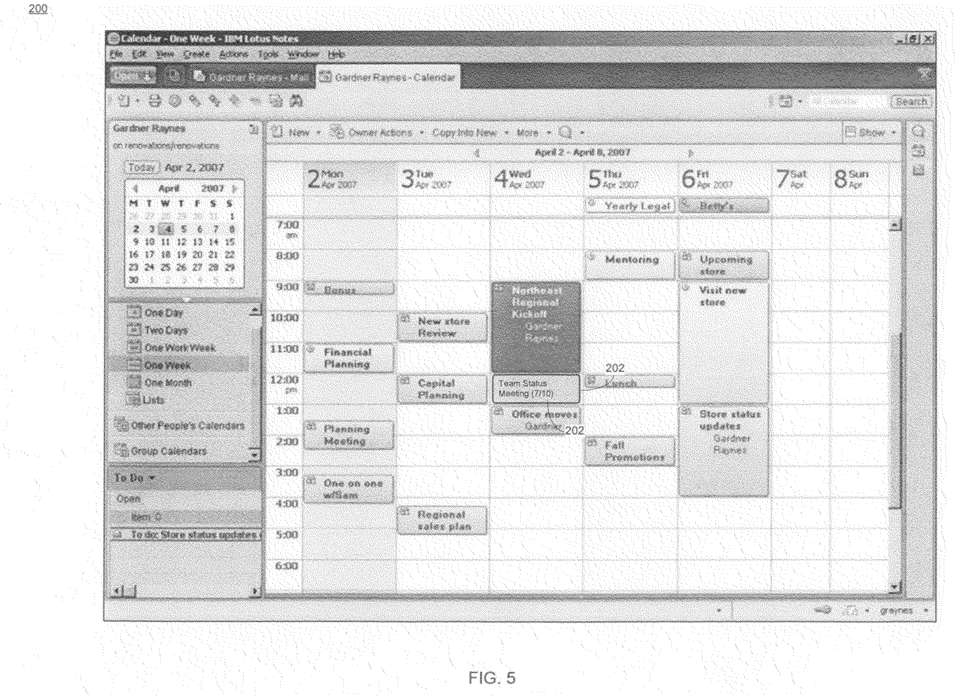

Attendance weighting process 10 may publish 166 the weighting factor associated 154 with the meeting attendee and the meeting. For example, and referring also to FIG. 5, attendance weighting process 10 may associate 154 a weighting factor of 7 with user 46 for attending the “Team Status Meeting”. Attendance weighting process 10 and/or email client application 22 may render calendar 200. Once user 46 accepts invitation 102 to the “Team Status Meeting”, email client application 22 and/or attendance weighting process 10 may render scheduled meeting 202 for the “Team Status Meeting” in calendar 200. Rendered weighting factor 204 (e.g., 7 out of 10) associated 154 with user 46 and the “Team Status Meeting” may be displayed in scheduled meeting 202 in calendar 200. One or more users (e.g., users 46,48, 50, 52) accessing calendar 200 may be informed of the weighting factor associated 154 with user 46 and the “Team Status Meeting”. As such, one or more of users 46, 48, 50, 52 may be apprised of the anticipated probability that user 46 will attend the “Team Status Meeting”.

In addition/as an alternative to a numerical weighting factor (e.g., rendered weighting factor 204) attendance weighting process 10 may publish 166 the weighting factor associated 154 with the meeting attendance in various other ways. For example, graphical indicators (e.g., listing order, color coding, symbols, and the like) may be used. For example, various meeting attendees may be ranked in scheduled meeting 202 in an order based upon, at least in part, the anticipated probability with which the attendee will attend the meeting. Similarly, meetings accepted by a user may be ranked according to the anticipated probability that the user will attend the various meetings. Other techniques for publishing 166 the weighting factor associated 154 with the meeting attendance may also/alternatively be used.

The published 166 attendance weighting factor may be used by other users attempting to invite a meeting attendee to conflicting meetings. For example, user 46 may have accepted an invitation to the “Team Status Meeting” and attendance weighting process 10 may have defined 152 a weighting factor of 8 (e.g., out of 10), which may be associated 154 with user 46 and the “Team Status Meeting.” The attendance weighting factor (i.e., 8) may be published 166 in a calendar. Another user intending to invite user 46 to a meeting conflicting with the “Team Status Meeting” may view the calendar and see that user 46 has already accepted a meeting for the time with a high probability of attendance. As such, the other user may recognize the low probability of scheduling a conflicting meeting including user 46 and select an alternative time. The published 166 attendance weighting factor may also be used in other to gauge the availability of a user.

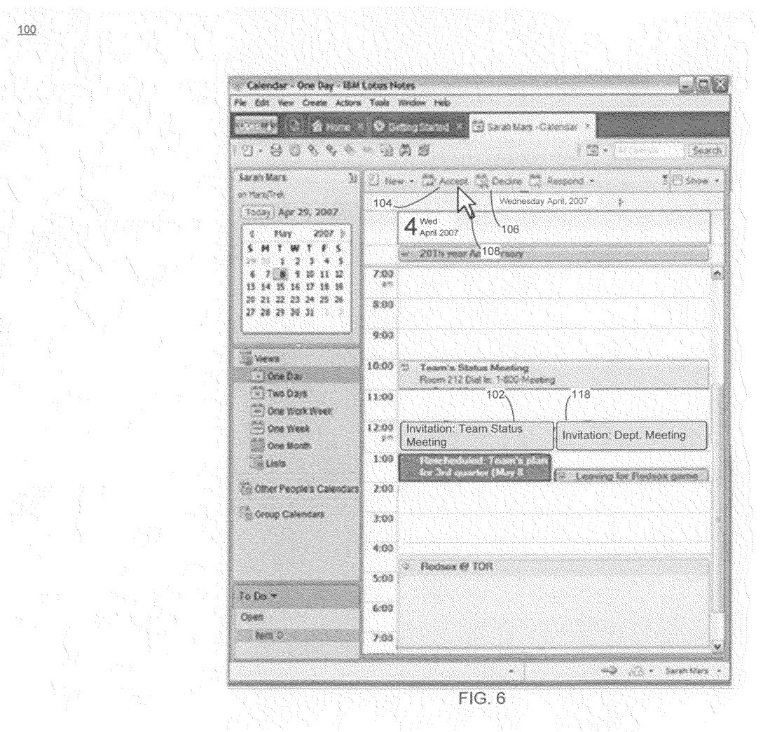

Continuing with the above-stated example, and referring also to FIG. 6, user 46 may receive another invitation to another meeting (e.g., invitation 118 to “Dept. Meeting” shown on display screen 100). Invitation 118 to the “Dept. Meeting” may conflict with invitation 102 to the “Team Status Meeting” (e.g., the scheduled times for the “Team Status Meeting” and the “Dept. Meeting” may at least partially overlap). As with invitation 102 to the “Team Status Meeting”, user 46 may accept or decline invitation 118 to the “Dept. Meeting” by selecting one of “Accept” button 104 and “Decline” button 106, e.g., using onscreen pointer 108 controlled by the pointing device.

If user 46 accepts invitation 118 to the “Dept. Meeting”, attendance weighting process 10 may receive 168 the acceptance to invitation 118 to the “Dept. Meeting”, which conflicts with the “Team Status Meeting”. Attendance weighting process 10 may define 170 a second weighting factor based upon, at least in part, an anticipated probability of user 46 attending the “Dept. Meeting”. Attendance weighting process 10 may associate 172 the second weighting factor with user 46 and the “Dept. Meeting”.

Continuing with the above-stated example, because user 46 has accepted a meeting invitation to a second conflicting meeting (i.e., invitation 118 to the “Dept. Meeting” that conflicts with accepted invitation 102 to the “Team Status Meeting”), the anticipated probability that user 46 will attend the “Team Status Meeting” may be changed. Attendance weighting process 10 may adjust 174 the weighting factor associated with user 46 and the “Team Status Meeting” based upon, at least in part, the second weighting factor associated 172 with user 46 and the “Dept. Meeting”. For example, if attendance weighting process 10 had associated 154 a weighting factor of 10 (e.g., indicating a 100% anticipated probability of attendance) with user 46 and the “Team Status Meeting”, user 46's acceptance of meeting invitation 118 to “Dept. Meeting” may reduce the anticipated probability that user 46 will actually attend the “Team Status Meeting”.

For example, attendance weighting process 10 may define 170 a weighting factor for the “Dept. Meeting” of 5 (out of 10), based upon two conflicting accepted meeting invitations. Based upon the weighting factor of 5 for the “Dept. Meeting”, attendance weighting process 10 may adjust 174 the weighting factor associated 154 with user 46 and the “Team Status Meeting”. For example, if the original weighting factor associated with the “Team Status Meeting” was 10, attendance weighting process 10 may adjust the weighting factor associated 154 with user 46 and the “Team Status Meeting” to 5 (out of 10). As such, the adjusted 174 weighting factor associated 154 with user 46 and the “Team Status Meeting” and the weighting factor associated 172 with user 46 and the “Dept. Meeting” may reflect an anticipated probability of 50% that user 46 will attend either meeting.

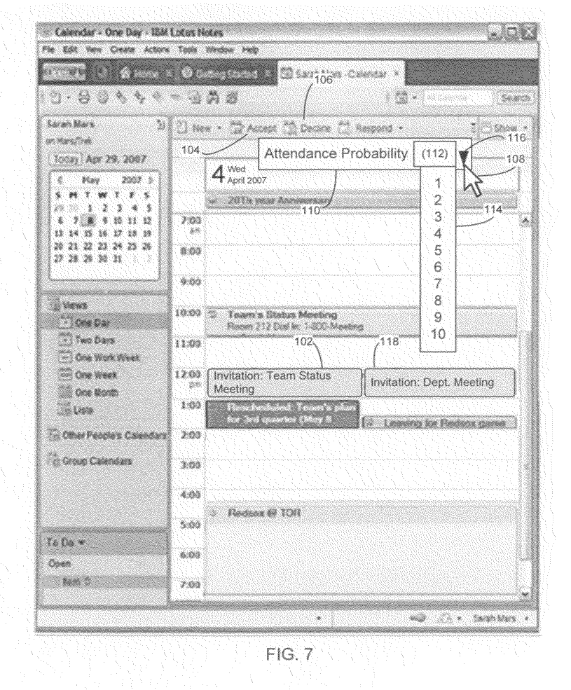

Adjusting 174 the first weighting factor (i.e., the weighting factor associated with user 46 and the “Team Status Meeting”) may include receiving 176 an anticipated probability of attendance at the “Dept. Meeting” for the user 46. For example, as with weighting factor defined 152 for the “Team Status Meeting”, user 46 may input an anticipated probability of attending the “Dept. Meeting”. Referring also to FIG. 7, selecting (e.g., using onscreen pointer 108 controlled by the pointing device) “Accept” button 104 may result in attendance weighting process 10 and/or email client application 22 rendering popup 110, including “attendance probability” filed 112. User 46 may input an anticipated probability for attending the “Dept. Meeting”, for example, using a keyboard (not shown) or selection menu 114. Attendance weighting process 10 may receive 176 the anticipated probability of user 46 attending the “Dept. Meeting”, and may adjust 174 the weighting factor associated 154 with user 46 and the “Team Status Meeting” based upon, at least in part, the received weighting factor for user 46 attending the “Dept. Meeting”.

The anticipated probability of attendance at the second meeting may be based upon, at least in part, the anticipated probability of attendance at the first meeting. For example, attendance weighting process 10 may receive 156 an anticipated probability of 7 (out of 10) that user 46 will attend the “Team Status Meeting”. If an equal probability of attendance at either the “Team Status Meeting” and the “Dept. Meeting” is assumed, attendance weighting process 10 may define 170 a weighting factor of 3.5 for user 46's anticipated probability of attending the “Dept. Meeting”. That is, the 7 (out of 10) anticipated probability originally defined for user 46 attending the “Team Status Meeting” may be assumed to be the anticipated probability of user 46 attending any meeting during the time period of the “Team Status Meeting”. Dividing the anticipated probability of 7 between the “Team Status Meeting” and the “Dept. Meeting” may result in an anticipated probability of 3.5 for user 46 attending each meeting. Of course, other decision algorithms and assumptions may also/alternatively be used.

Attendance weighting process 10 may update 178 one of the weighting factor associated with user 46 and the “Team Status Meeting” and the weighting factor associated 172 with user 46 and the “Dept. Meeting” based upon, at least in part, a resolution of the conflict between the “Team Status Meeting” and the “Dept. Meeting”. For example, the “Team Status Meeting” may be cancelled or rescheduled to a time that does not conflict with (e.g., does not at least partially overlap with) the “Dept. Meeting”. In an example in which a weighting factor of 5 (out of 10) is associated with the “Team Status Meeting” and a weighting factor of 5 (out of 10) is associated with the “Dept. Meeting”, there is an anticipated probability that user 46 will attend one or the other meeting (i.e., a total weighting factor of 10 out of 10). When the conflicting “Team Status Meeting” is cancelled or rescheduled, attendance weighting process 10 may update the weighting factor associated with the “Dept. Meeting” to reflect the increased anticipated probability that user 46 will attend the “Dept. Meeting”. For example, attendance weighting process may update 178 the weighting factor associated with the “Dept. Meeting” to 10 (out of 10). If weighting factors are associated with more than two conflicting meetings, when one of the conflicting meetings is cancelled or rescheduled, attendance weighting process 10 may update 178 the weighting factors of the remaining conflicting meetings proportionally to the relative weighting factors associated 154 with the remaining meetings.

The various features and aspects based upon which, at least in part, the weighting factor associated with user 46 and the “Team Status Meeting” may be defined, are equally applicable to the weighting factor associated with user 46 and the “Dept. Meeting”. For example, the weighting factor associated with user 46 and the “Dept. Meeting” may be based upon, at least in part, an attendance history or user 46, an availability of user 46, and awareness of the meeting by user 46, and so on. Additionally, the “Dept. Meeting” may be divided into subparts, attendance weighting process 10 defining a weighting factor corresponding to each sub part. It should be appreciated that one or more subpart of the “Team Status Meeting” may not conflict with the “Dept. Meeting” and/or one or more subparts of the “Dept. Meeting”, and vice versa. Weighting factors defined for the “Team Status Meeting”, the “Dept. Meeting”, and/or subparts of either meeting, may be defined based on conflicts and/or lack of conflicts between various meetings and meeting subparts. Additionally, attendance weighting process 10 may publish the weighting factor associated with user 46 and the “Dept. Meeting”.

A number of implementations have been described. Nevertheless, it will be understood that various modifications may be made. Accordingly, other implementations are within the scope of the following claims.

What is claimed is:

1. A method comprising:
receiving an acceptance to an invitation to a first meeting for a meeting invitee;
defining a first weighting factor for the meeting invitee based upon, at least in part, an anticipated probability of attendance at the first meeting by the meeting invitee;
associating the first weighting factor with the meeting invitee and the first meeting.

2. The method of claim 1, wherein defining the first weighting factor includes receiving an anticipated probability of attendance for the meeting invitee.

3. The method of claim 1, wherein the first weighting factor is based upon, at least in part, an attendance history of the meeting invitee.

4. The method of claim 1, wherein the first weighting factor for the meeting invitee is based upon, at least in part, an availability of the meeting invitee.

5. The method of claim 1, wherein defining the first weighting factor further includes defining at least a first meeting subpart and defining a second meeting subpart, defining the first weighting factor including defining a first subpart weighting factor based upon, at least in part, an anticipated probability of attendance at the first meeting subpart and defining a second subpart weighting factor based upon, at least in part, an anticipated probability of attendance at the second meeting subpart.

6. The method of claim 1, further including publishing the first weighting factor associated with the meeting invitee.

7. The method of claim 1, further including:
receiving an acceptance to an invitation to a second meeting for the meeting invitee, the second meeting conflicting with the first meeting;
defining a second weighting factor for the meeting invitee based upon, at least in part, an anticipated probability of attendance at the second meeting by the meeting invitee;
associating the second weighting factor with the meeting invitee and the second meeting; and
adjusting the first weighting factor associated with the meeting invitee and the first meeting based upon, at least in part, the second weighting factor.

8. The method of claim 7, wherein adjusting the first weighting factor includes receiving an anticipated probability of attendance at the second meeting for the meeting invitee.

9. The method of claim 7, wherein the anticipated probability of attendance at the second meeting is based upon, at least in part, the anticipated probability of attendance at the first meeting received from the meeting invitee.

10. The method of claim 7, further including updating one of the first weighting factor and the second weighting factor based upon, at least in part, a resolution of the conflict between the first meeting and the second meeting.

11. A computer program product residing on a computer readable medium having a plurality of instructions stored thereon which, when executed by a processor, cause the processor to perform operations comprising:
receiving an acceptance to an invitation to a first meeting for a meeting invitee;
defining a first weighting factor for the meeting invitee based upon, at least in part, an anticipated probability of attendance at the first meeting by the meeting invitee;
associating the first weighting factor with the meeting invitee and the first meeting.

12. The computer program product of claim 11, wherein the instructions for defining the first weighting factor include instructions for receiving an anticipated probability of attendance for the meeting invitee.

13. The computer program product of claim 11, wherein the first weighting factor is based upon, at least in part, an attendance history of the meeting invitee.

14. The computer program product of claim 11, wherein the first weighting factor for the meeting invitee is based upon, at least in part, an availability of the meeting invitee.

15. The computer program product of claim 11, wherein the instructions for defining the first weighting factor further include instructions for defining at least a first meeting subpart and for defining at least a second meeting subpart, the instructions for defining the first weighting factor further including instructions for defining a first subpart weighting factor based upon, at least in part, an anticipated probability of attendance at the first meeting subpart and for defining a second subpart weighting factor based upon, at least in part, an anticipated probability of attendance at the second meeting subpart.

16. The computer program product of claim 11, further including instructions for publishing the first weighting factor associated with the meeting invitee.

17. The computer program product of claim 11, further including instructions for:
receiving an acceptance to an invitation to a second meeting for the meeting invitee, the second meeting conflicting with the first meeting;
defining a second weighting factor for the meeting invitee based upon, at least in part, an anticipated probability of attendance at the second meeting by the meeting invitee;
associating the second weighting factor with the meeting invitee and the second meeting; and
adjusting the first weighting factor associated with the meeting invitee and the first meeting based upon, at least in part, the second weighting factor.

18. The computer program product of claim 17, wherein the instructions for adjusting the first weighting factor include instructions for receiving an anticipated probability of attendance at the second meeting for the meeting invitee.

19. The computer program product of claim 17, wherein the anticipated probability of attendance at the second meeting is based upon, at least in part, the anticipated probability of attendance at the first meeting received from the meeting invitee.

20. The computer program product of claim 17, further including instructions for updating one of the first weighting factor and the second weighting factor based upon, at least in part, a resolution of the conflict between the first meeting and the second meeting.
